(19) United States
(12) Patent Application Publication
(10) Pub. No.: US 2022/0026054 A1
(43) Pub. Date: Jan. 27, 2022

(54) LED LIGHTING DEVICE FOR CULTIVATED SURFACES

(71) Applicant: LUX LEDLIGHTING S.R.L., Bedizzole (Brescia) (IT)

(72) Inventor: Cesare ALBERTI, Bedizzole (Brescia) (IT)

(21) Appl. No.: 17/296,704

(22) PCT Filed: Oct. 4, 2019
(86) PCT No.: PCT/IB2019/058470

§ 371 Date: May 25, 2021

(51) Int. Cl. F21V 29/76; F21V 5/00; F21V 31/00

(52) U.S. Cl. CPC F21V 29/763; F21Y 2115/10; F21V 31/005; F21V 5/007

(57) ABSTRACT

An LED lighting device for irradiating a cultivated surface includes a support made of thermally conductive material, optical bodies, a thin and flexible membrane, and an LED board superimposed on and in contact with the thin and flexible membrane and configured so that each LED faces the thin and flexible membrane and is aligned with a respective optical body. The configuration of the LED lighting device improves thermal transfer towards the cultivated surface.

The subject-matter of the present invention is an LED lighting device intended to irradiate a cultivated surface, for example provided with seeds or plants, to cause, stimulate or accelerate the growth, inflorescence and fructification thereof.

The expedient of illuminating a cultivated surface to accelerate the growth of the cultivation has been well known for a long time and at present is used particularly in various sectors, from cultivating flowers, fruits and vegetables in greenhouses to growing grass on playgrounds.

For some years now, in the field of lighting devices, one has witnessed the replacement of traditional fluorescent, halogen and high-pressure sodium lights with LED lights, which provide a clear energy savings for the same lighting and a much longer average life.

However, in the field of lighting devices for the irradiation of cultivated surfaces, the advent of LED lights, if on the one hand has improved the transfer of radiant energy, reducing consumption, on the other has significantly reduced the transfer of thermal energy from the light source to the cultivated surface, due to the nature of LED light, which is low in infrared, and the cooling modes typical of LED lighting devices.

The object of the present invention is to obtain an LED lighting device for cultivated surfaces that overcomes the drawbacks mentioned above.

This object is achieved by an LED lighting device obtained according to claim 1. The dependent claims describe further advantageous embodiments.

The features and advantages of the LED lighting device according to the present invention will be apparent from the description given hereinafter, provided by way of non-limiting example, in accordance with the accompanying figures, wherein:

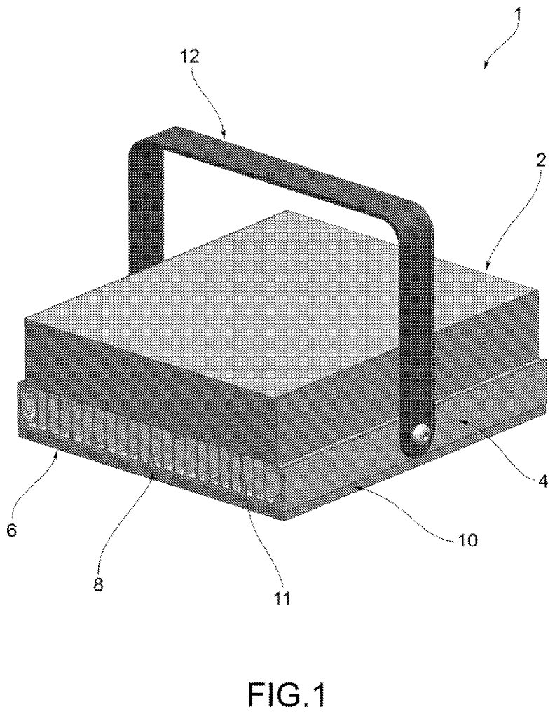

FIG. 1 shows a lighting device according to an embodiment of the present invention;

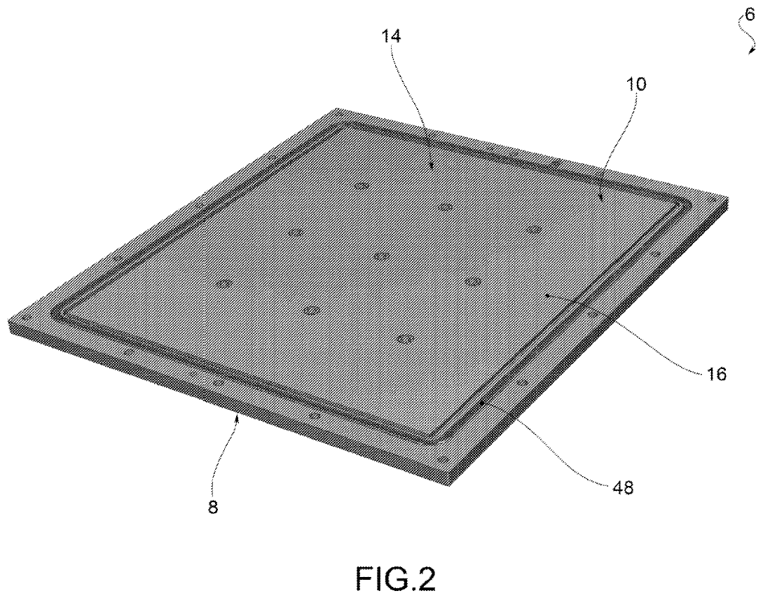

FIG. 2 shows a lighting group of the lighting device;

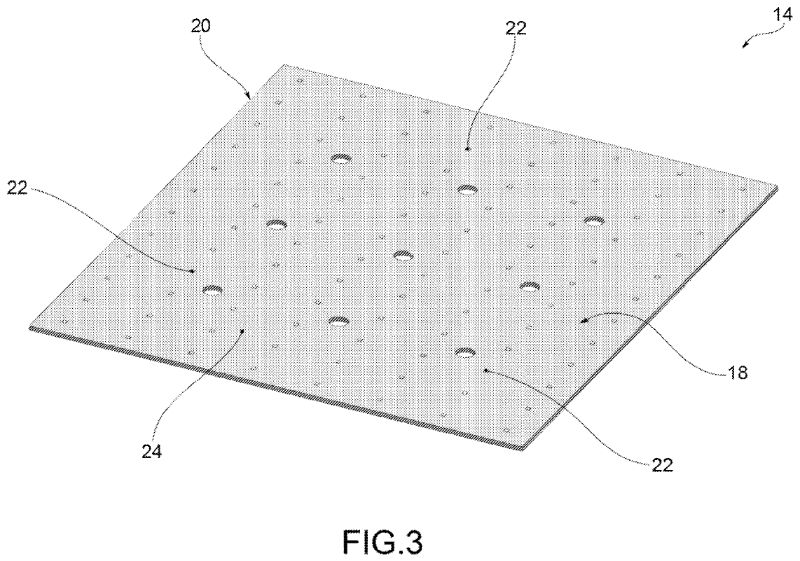

FIG. 3 illustrates an LED board of the lighting device;

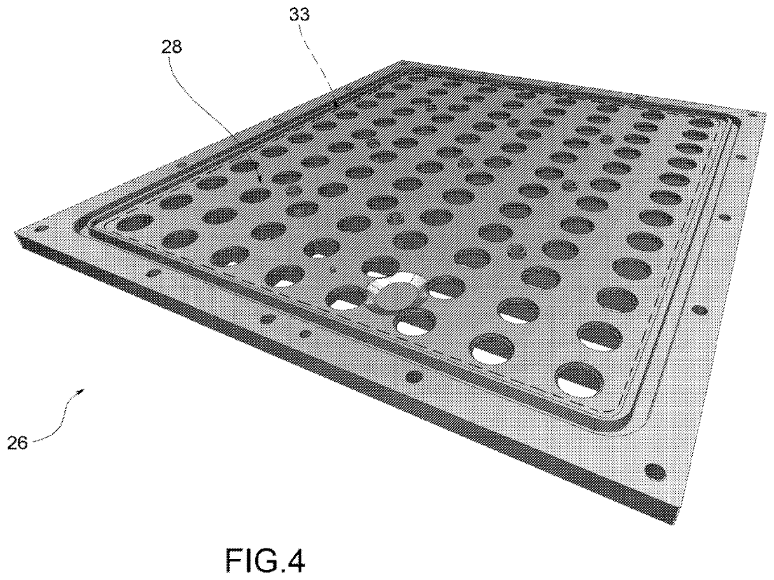

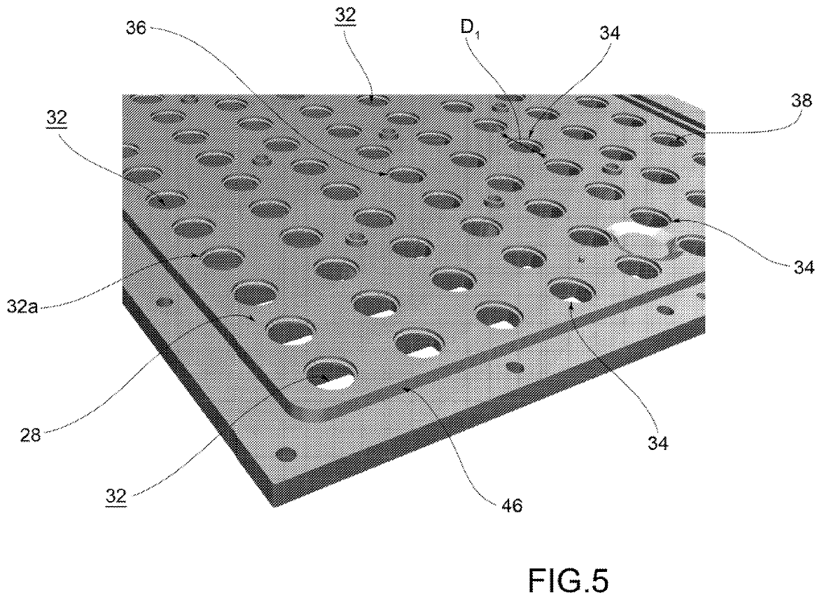

FIGS. 4 and 5 show, respectively, a main support for the lighting device from the side of the upper face and an enlargement thereof;

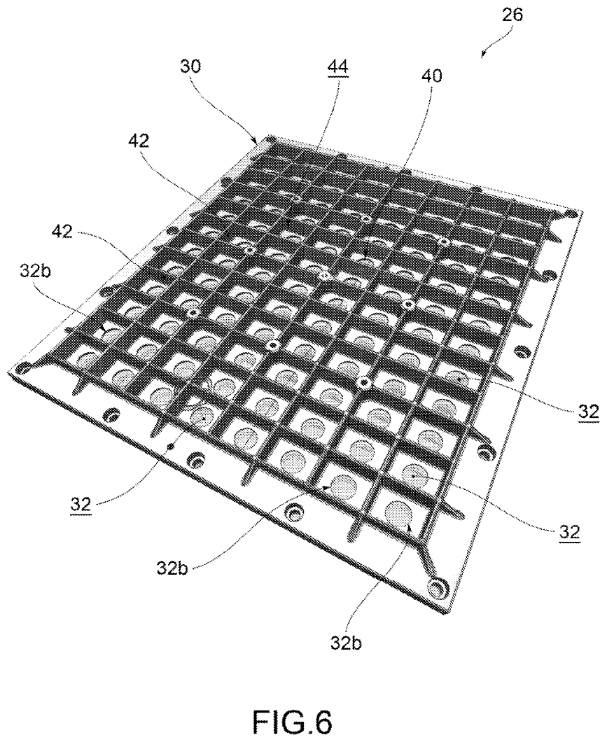

FIG. 6 shows the main support, from the side of the lower face;

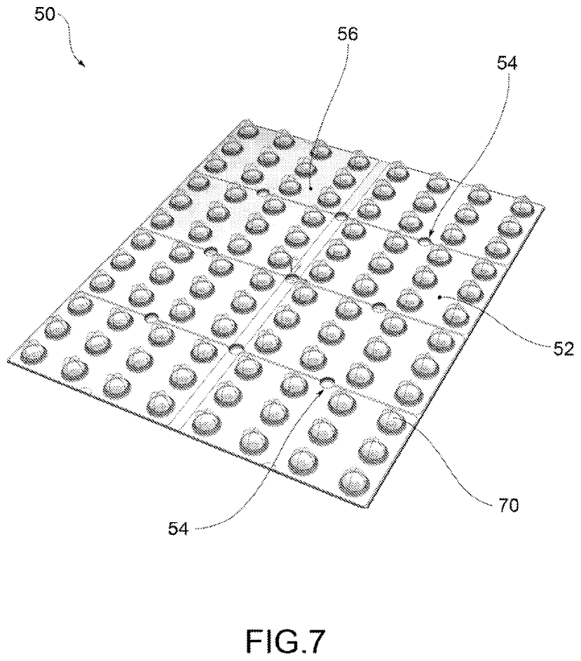

FIG. 7 illustrates a functional group of the lighting device;

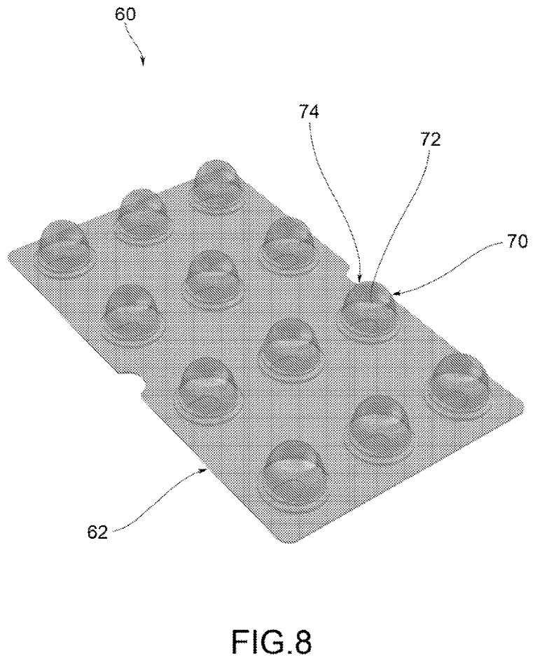

FIG. 8 shows a functional group portion of the lighting device;

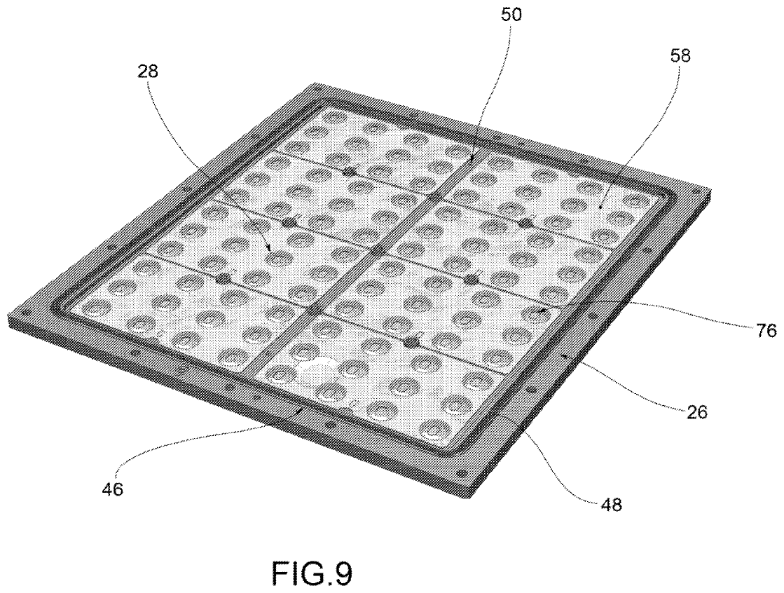

FIG. 9 shows an assembly comprising the main support and the functional group, from the side of the upper face;

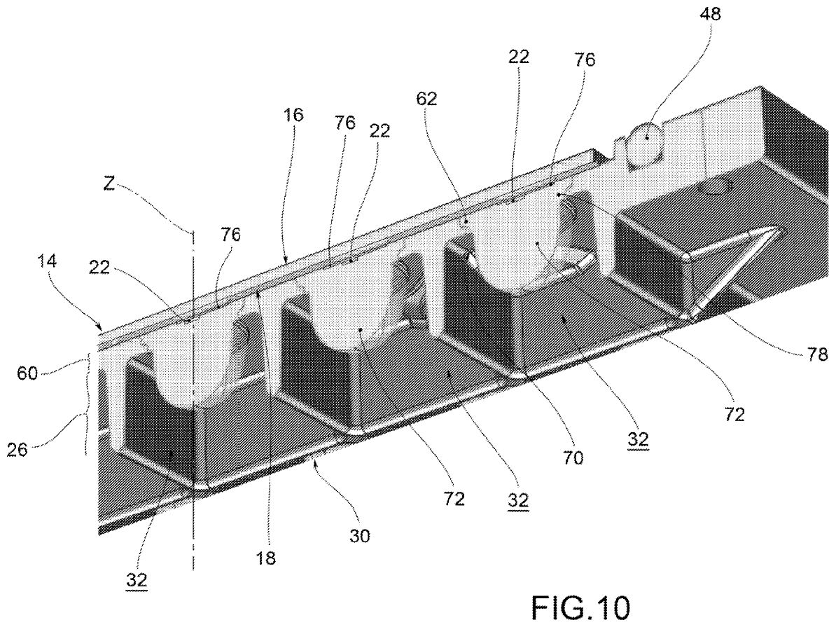

FIG. 10 illustrates a cross-sectional view of the lighting group in FIG. 2;

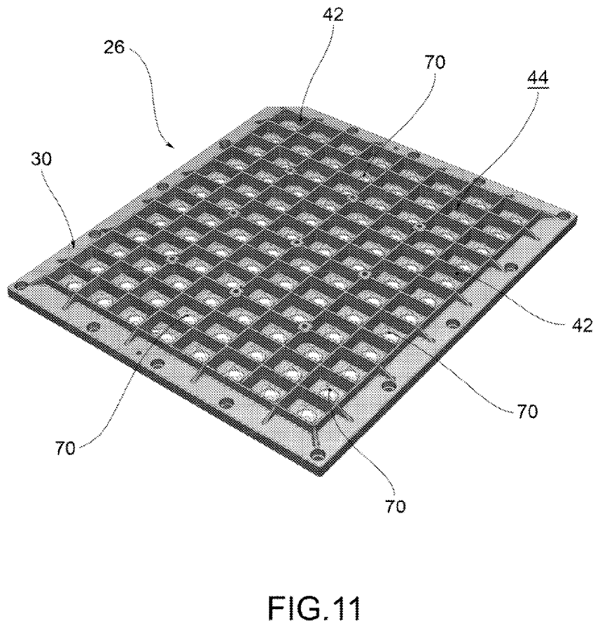

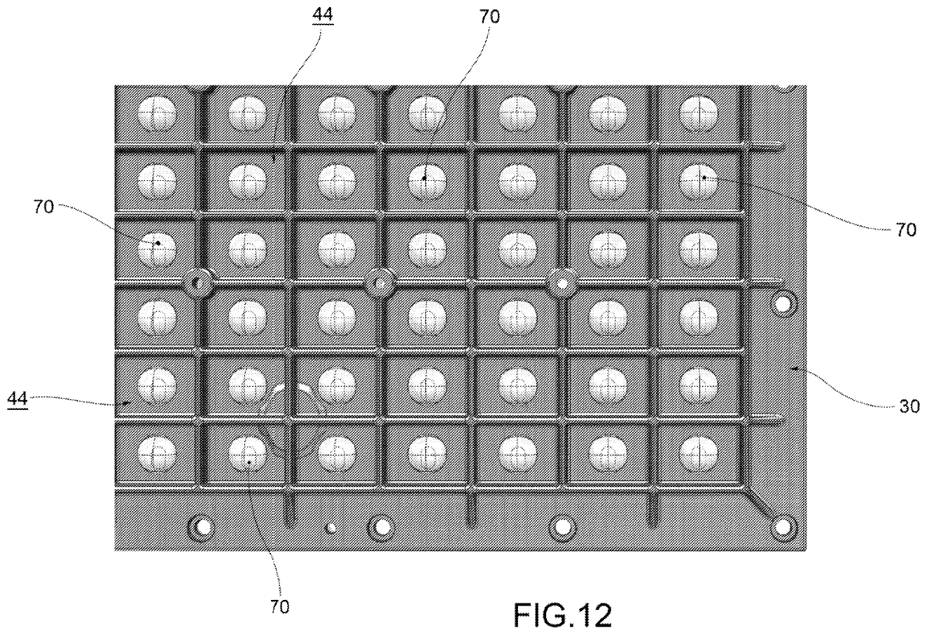

FIGS. 11 and 12 show respectively the main support-functional group assembly from the side of the lower face and an enlargement thereof.

With reference to the accompanying figures, an LED lighting device for cultivated surfaces has been indicated collectively at 1, comprising a control box 2, within which there are electrical components for the power supply and control of the LEDs, a heat sink 4 and a lighting group 6 (FIG. 1).

The lighting group 6 has a plate-shaped configuration and has a lower face 8 for light irradiation and an upper face 10, against which the heat sink 4 is placed.

For example, the heat sink 4 is made of aluminum and, on the side opposite to the one facing the lighting group 6, provides for a plurality of spaced slats 11.

The control box 2 is located over the heat sink 4, for example in contact with the slats 11.

Preferably, the lighting device 1 comprises a bracket 12, usually hinged to the heat sink 4.

The lighting group 6 comprises an LED board 14 with a substantially smooth upper surface 16 and a lower surface 18 on which is housed an LED matrix 20 consisting of a plurality of LEDs 22, preferably arranged in rows and columns, and a printed circuit board 24 to attach the LEDs 22 and distribute the supply current (FIGS. 2 and 3).

The lighting group 6 further comprises a main support 26 (FIGS. 4 to 6), preferably consisting of a plate-shaped body made in a single piece of metal material, preferably aluminum, suitably shaped on both sides.

In particular, the support 26 has an upper face 28 and a lower face 30, corresponding to the lower face 8 of the lighting group 6.

The support 26 has a plurality of holes 32, preferably circular, passing from the upper face 28, wherein there is a respective inlet opening 32a, to the lower face 30, where there is a respective outlet opening 32b, through the thickness of the support 26.

The inlet openings 32a of the holes 32 together occupy, on the upper face 28 of the support 26, a hole region 33.

Said holes 32 are arranged in such a way that, when the LED board 14 is mounted to the upper face 28 of the support 26, each LED 22 is aligned with a respective hole 32, i.e., each LED faces the inlet opening 32a of the respective hole 32.

Said inlet opening 32a, flush with the upper face 28, has a first predefined characteristic dimension D1, for example the diameter in the case of a circular hole, and, lowered relative to the inlet opening 32a, a secondary opening 36 having a second predefined characteristic dimension D2.

The secondary opening 36 forms a narrowing of the hole 32; the first characteristic dimension D1 is therefore larger than the second characteristic dimension D2 (D1>D2).

Between the two openings 32a, 36 there is thus a step that defines a hole seal seat 38, which will be discussed hereinafter.

In addition, preferably, the support 26 comprises a support seal seat 46 extending peripherally on the upper face 28, surrounding the hole region 33 of the upper face 28.

Said support seal seat 46 is preferably milled so as to be lower relative to the upper face 28 and extends continuously along the periphery of the support.

The support seal seat 46 is intended to accommodate a support seal 48 of the lighting group 6, formed by an annular gasket (FIG. 2).

Once the LED board 14 is mounted to the support 26, the support seal seat 46, and obviously the support seal 48, surround said LED board 14.

On the lower face 30, the support 26 preferably has a grid structure 40, comprising a plurality of septa 42, for example with prevalent transverse and longitudinal extension, which intersect to form a plurality of niches 44. Within each niche 44 opens a respective hole 32.

The lighting group 6 further comprises a functional group 50 comprising a preferably flexible membrane 52 made, for example, of an elastomeric material, such as a silicone, with good thermal conductivity.

The membrane 52 is thin, i.e., having a thickness of 1.5 millimeters or less, preferably less than 1 millimeter, and even more preferably less than or equal to 0.6 millimeters.

The membrane 52 is geometrically configured to completely cover the region of the support 26 provided with the holes 32 (with the exception, for example, of some localized passages 54 for the mechanical connection between the support 26 and the heat sink 4).

Once the lighting group 6 has been assembled, the membrane 52 is arranged in contact with the upper face 28 of the support 26 and covers the entire region thereof provided with the holes 32 (FIG. 9).

The LED board 14 is then arranged above the membrane 52 in contact with the same membrane.

In other words, the lighting group 6 has a sandwich structure, wherein the membrane 52 is arranged between the upper face 28 of the support 26, in contact therewith, and the lower surface 18 of the LED board 14, in contact therewith.

Ultimately, the membrane 52 has a lower face 56, which is in contact with the upper face 28 of the support 26, and an upper face 58, which is in contact with the lower surface 18 of the LED board 14.

According to a preferred embodiment, the membrane 52 consists of a plurality of membrane portions 62, each of which has, for example, a rectangular shape, structurally separated from each other, which, when placed side by side, comprise the membrane 52 (FIG. 8).

The membrane 52 or membrane portions 62, resting on the upper face 28 of the support 26 and on which the LED board 14 rests, are mechanically detached from the upper face 28 and from the LED board; in other words, they are not fixed thereto, for example by rivets or adhesive, as is the case with certain LED lighting devices of the prior art.

Advantageously, this allows one to disregard the thermal expansion of the support or LED board, which is different from that of the membrane.

The lighting group 6 further comprises a plurality of optical elements 70 having optical properties so as to concentrate or distribute the light beam emitted by an LED, as required. Said optical elements 70 are suitable to be mounted to the support 26.

Each optical element 70 preferably consists of a solid optical body 72 having an outer surface 74, in the form of a dome, made of material transparent to the light emitted by the LEDs 22, preferably made of an elastomeric material, for example silicone; said optical body 72 is suitable to be housed in a respective hole 32, so that the convex outer surface 74, arranged inside the respective hole 32, is turned toward the lower face 30 of the support 26.

According to an embodiment, the optical body 72 has an axial symmetrical configuration relative to a main axis Z, and the outer surface 74 derives from the complete rotation around the main axis Z of a parabolic curve.

According to other variants, the optical body has a different shape, in order to convey the luminous flux where necessary, also as a function of the distance and width of the surface to be irradiated.

Preferably, moreover, the membrane 62 has a plurality of pockets 76 obtained on the upper face 58, lowered with respect thereto, each pocket 76 corresponding to a respective optical body 72 and arranged so as to be aligned with the main axis Z of said optical body 72. In other words, the main axis Z of each optical body 72 intersects a respective pocket 76.

Preferably, each pocket 76 has a depth equal to the thickness of the membrane 52.

When the LED board 14 is mounted over the membrane 52, each LED 22 is aligned with a respective pocket 76, i.e., the irradiation cone of said LED 22 enters the respective pocket 76, so that it is intercepted by the respective optical body 72.

Furthermore, according to a preferred embodiment, each optical element 70 comprises a hole seal 78 consisting of an annular element suitable to be housed in the hole seal seat 38 of the support 26.

Preferably, the hole seal 78 is made of an elastomeric material, preferably silicone.

Preferably, moreover, the hole seal 78 is made in one piece with the optical body 72.

According to a preferred embodiment, moreover, the membrane 52 and the optical elements 70 are made in one piece, for example by means of injection molding, of an elastomeric material, for example silicone.

In this embodiment, the functional group 50 is thus made up of a single piece, formed by the membrane 52 and by the plurality of optical elements 70 protruding from the lower face 56 of the membrane 52, organized according to a matrix the positions of which correspond to those of the holes 32 of the support 26, so that each optical element 70 may be inserted into the respective hole 32.

Preferably, said functional group 50 consists of a plurality of structurally separate functional group portions 60, each in a single piece consisting of a membrane portion 62 and a predefined number of optical elements 70. By combining the membrane portions 62, the functional group 50 is obtained.

Innovatively, the LED lighting device described above meets the needs of the industry with regard to the supply of thermal energy to the cultivated surface, as the heat developed by the LED board finds a preferred transmission pathway to the support 26 via the membrane 62.

Advantageously, in effect, the membrane has a good thermal conductivity, due to the polymeric material and to the dimensional characteristics, so as to transfer the heat from the LED board to the support. The support, moreover, is made of material with high thermal conductivity, so as to transfer the heat to the outside.

In other words, the amount of thermal energy that is transferred from the LEDs to the outside environment by the front support, and therefore in the direction of the cultivated surface, is considerable if not greater than that which is transferred to the outside by the heat sink and by the other components.

Advantageously, moreover, the seal created by the support seal and the hole seal allows the device described above to be used in a very humid environment or in contact with water, as is the environment of greenhouses or nurseries.

According to a further advantageous aspect, the lack of mechanical bonds between the membrane or the membrane portions and the support, or between the membrane or the membrane portions and the LED board, makes it possible to disregard the effect of the thermal expansion of the support and the LED board, which is different from that of the membrane (which in some LED lighting devices of the prior art is instead a cause of rupture of the support structure of the optical means).

It is clear that one skilled in the art, in order to meet contingent needs, may make changes to the LED lighting device described above, all contained within the scope of protection as defined by the following claims.

1. An LED lighting device for irradiating a cultivated surface, the LED lighting device comprising:
a support made of thermally conductive material, having a lower face configured to be turned toward the cultivated surface, and an opposite upper face, the support comprising a plurality of holes passing from the upper face to the lower face, wherein inlet openings of said holes on the upper face collectively occupy a hole region of said upper face;
a plurality of optical bodies suitable to concentrate or distribute an irradiation cone, each optical body being inserted in a respective hole so as to concentrate or distribute the irradiation cone exiting the lower face;
a thin and flexible membrane, in contact with the upper face of the support, so as to cover the hole region; and
an LED board comprising a plurality of LEDs, superimposed on and in contact with the thin and flexible membrane, configured so that each LED is turned toward the thin and flexible membrane and aligns with a respective optical body.

2. The LED lighting device of claim 1, wherein the thin and flexible membrane is made of an elastomer.

3. The LED lighting device of claim 1, wherein the thin and flexible membrane has a thickness of less than 1.5 millimeters.

4. The LED lighting device of claim 1, wherein each optical body is a solid body made of an elastomeric material, including silicone rubber.

5. The LED lighting device of claim 1, wherein each optical body has a dome-shaped outer surface for escape of the irradiation cone.

6. The LED lighting device of claim 1, wherein the thin and flexible membrane and the plurality of optical bodies are made as a single piece, wherein the optical bodies protrude from a lower face of the thin and flexible membrane, and an upper face of the thin and flexible membrane is turned toward said plurality of LEDs.

7. The LED lighting device of claim 1, comprising a plurality of hole seals, each hole seal being associated with a respective optical body, said hole seal being suitable to form a seal between the lower face and the upper face of the support.

8. The LED lighting of claim 7, wherein each hole at the inlet opening has a hole seal seat housing a respective hole seal.

9. The LED lighting device of claim 7, wherein the thin and flexible membrane and the plurality of optical bodies are made as a single piece, wherein the optical bodies protrude from a lower face of the thin and flexible membrane, and an upper face of the thin and flexible membrane is turned toward said plurality of LEDs, and wherein the hole seals are made in one piece with the thin and flexible membrane and the optical bodies.

10. The LED lighting device of claim 1, wherein the thin and flexible membrane is mechanically detached from the support and/or from the LED board.

11. The LED lighting device of claim 1, wherein the thin and flexible membrane consists of a plurality of structurally separate membrane portions, which, side-by-side, form said thin and flexible membrane.

12. The LED lighting device of claim 11, wherein each membrane portion is associated with a predefined number of optical bodies and said optical bodies are made in one piece with said membrane portion.

13. The LED lighting device of claim 1, wherein, on the upper face, the thin and flexible membrane comprises a plurality of pockets lowered relative to said upper face, each pocket being aligned with a respective optical body and a respective LED.

14. The LED lighting device of claim 13, wherein each pocket has a depth equal to a thickness of the membrane.

15. The LED lighting device of claim 1, wherein each LED is in contact with the upper face of the thin and flexible membrane.

16. The LED lighting device of claim 1, wherein the support further comprises a support seal seat extending on the upper face and surrounding the hole region, said support seal seat being lowered relative to the upper face and configured to accommodate a support seal.

17. The LED lighting device of claim 1, comprising a heat sink mounted superimposed on the LED board.

18. The LED lighting device of claim 17, comprising a control box mounted superimposed on the heat sink, containing electrical components for powering and controlling the plurality of LEDs.

19. The LED lighting device of claim 1, comprising a bracket for transporting and positioning the LED lighting device over the cultivated surface.

20. The LED lighting device of claim 1, wherein the support is made as a single piece.
